(19) United States
(12) Patent Application Publication
(10) Pub. No.: US 2007/0019731 A1
(43) Pub. Date: Jan. 25, 2007

(54) Method for calculating a direct mode motion vector for a bi-directionally predictive-picture

(76) Inventor: Tsung-Chieh Huang, Tao Yuan Hsien (TW)

Correspondence Address: WENDEROTH, LIND & PONACK L.L.P., 2033 K. STREET, NW, SUITE 800, WASHINGTON, DC, 20006, US

(21) Appl. No.: 11/488,857

(22) Filed: Jul. 19, 2006

(30) Foreign Application Priority Data
Jul. 20, 2005 (JP) 2005-210021

(51) Int. Cl. H04N 11/04; H04N 11/02; H04N 7/12

(52) U.S. Cl. 375/240.15; 375/240.16; 375/240.26

(57) ABSTRACT

A method for calculating a direct mode motion vector for a bi-directionally predictive-picture includes: calculating S based on TRB, TRD, and N; calculating Tx based on MVx, the S, and the N; calculating Ty based on MVy, the S, and the N; obtaining a sum of the Tx, MVDx and δ1x, and using the obtained sum as MVFx; obtaining a sum of the Ty, MVDy and δ1y, and using the obtained sum as MVFy; obtaining a sum of the MVFx, δ2x, and a minus value of the MVx, and using the obtained sum as MVBx; and, obtaining a sum of the MVFy, δ2y, and minus value of the MVy, and using the obtained sum as MVBy.

### BACKGROUND OF THE INVENTION

1. Field of the Invention

This invention relates to a method for calculating a direct mode motion vector, and more specifically, relates to a method for calculating a motion vector of a direct mode block in a bi-directionally predictive-picture (B-picture or B-video object plane(VOP)) in an MPEG-4 video object.

2. Description of the Related Art

During playback of MPEG files, more than 30 pictures have to be reproduced within one second in order that there will not be the problem of motion discontinuity. Besides, since two consecutive pictures generally have many overlapping (similar) portions, three different techniques, i.e., I-pictures (Intra-coded pictures), B-pictures (bi-directionally predictive-coded pictures) and P-pictures (Predictive-coded pictures), are used in MPEG to compress pictures. The I-picture stores a complete picture so and does not need to consider its relationship with other pictures. The P-picture may store only a portion that is different from a portion of a preceding I-picture or P-picture and use the preceding I-picture or P-picture as a reference picture. The B-picture may store only a portion that is different from a portion of a reference picture and refer to a preceding or following I-picture or P-picture as the reference picture. Therefore, consecutive pictures will be compressed and arranged in the manner as shown in FIG. 1. Generally, an order of reproduction of pictures is not always the same as an order of decoding of the pictures in MPEG.

In the new-generation picture compression techniques, such as H.264 or part 10 of the MPEG-4 specification, a B-picture is further classified into five predictive modes, namely, list 0 mode, list 1 mode, bi-predictive mode, direct mode, and intra mode.

In the direct mode, a motion vector can be obtained using at least one of a spatial technique and a temporal technique.

The former (spatial technique) is used to obtain an index and a motion vector of a list 0 reference picture and a list 1 reference picture from adjacent blocks of an encoded block in the B-picture.

Referring to FIGS. 2A and 2B, the latter is used to obtain a list 0 motion vector MVF and a list 1 motion vector MVB by scaling a list 0 motion vector of a collocated block in the list 1 reference picture. With referencing to FIG. 1, the list 1 reference picture refers to a picture of which list 1 predictive index is 0, whereas the list 0 reference picture refers to a picture to which a motion vector MV of a collocated block in the list 1 reference picture points, as shown in FIGS. 2A and 2B. The “collocated block” is a block of a reference picture located in the same position in the screen as the position of a block of a B-picture which is currently decoded.

In the MPEG-4 specification (ISO/IEC14496-2), for the decoding of B-picture blocks, the following formulas are used to calculate the motion vectors of direct mode blocks in the B-picture:

$$MVFx = ( TRB ⨯ MVx ) / TRD + MVDx \\ MVBx = \{ \begin{matrix}( ( TRB - TRD ) ⨯ MVx ) / TRD & ( when MVDx = 0 ) \\ MVFx - MVx & ( when MVDx \neq 0 )\end{matrix} \\ MVFy = ( TRB ⨯ MVy ) / TRD + MVDy \\ MVBx = \{ \begin{matrix}( ( TRB - TRD ) ⨯ MVy ) / TRD & ( when MVDy = 0 ) \\ MVFy - MVy & ( when MVDy \neq 0 )\end{matrix} \qquad ( eq . 1 )$$

where all the variables are integers, “/” denotes division with rounding toward zero.

FIG. 2A is a diagram showing a relation among the vectors MV, MVF, MVB, and MVD and scalar quantities TRB and TRD related to time, when the vector MVD is a zero vector. FIG. 2B is a diagram showing the above mentioned relation, when the vector MVD is not a zero vector.

As shown in FIGS. 2A and 2B, the motion vector MV=(MVx,MVy), MVx and Mvy respectively representing components of the vector MV in the horizontal direction (x direction) and the vertical direction (y direction), is a vector formed between the collocated block of the list 1 reference picture, which is located on the same position as that of the current block in the B-picture, and a block in the list 0 reference picture.

TRB represents the temporal distance between the list 0 reference picture and the B-picture.

TRD represents the temporal distance between the list 0 reference picture and the list 1 reference picture.

The vector MVD=(MVDx, MVDy), MVDx and MVDy respectively representing components of the vector MVD in the horizontal direction (x direction) and the vertical direction (y direction), is a differential motion vector formed so that the vector MVF may direct to the most similar adjacent block of the list 0 reference picture from the current block and the vector MVB may direct to the most similar adjacent block of the list 1 reference picture.

However, since all of the aforesaid four formulas (eq. 1) employ division operation. Furthermore, integer division operation is quite time-consuming for a microprocessor. As shown in FIG. 3, when the microprocessor uses a conventional function Bin_Div (to be described) to realize the division operation in the aforesaid four formulas (eq. 1), the average total number of operations required for calculating a set of direct mode motion vectors (i.e., MVFx, MVFy, MVBx, and MVBy) of the block is as high as 332, which is likely to affect the temporal efficiency of picture decoding.

Therefore, for decoding a B-picture, it is necessary to perform a time-consuming integer division operation for each block. Thus, in order to meet the demand for real-time decoding, it is necessary to use a microprocessor or a hardware divider with high computing speeds. However, a hardware divider is not only bulky in terms of circuitry, it also consumes high power and is expensive.

Therefore, U.S. Patent Publication No. US2004/0066848 for “Direct mode motion vector calculation method for B picture” discloses a direct mode motion vector calculation method that can simplify the aforesaid process of computations. The equations disclosed are as follows:

$$Z = TRB ⨯ 256 / TRD \\ MVFx = ( Z ⨯ MVx + 128 ) >> 8 + MVDx \\ W = Z - 256 \\ MVBx = \{ \begin{matrix}( W ⨯ MVx + 128 ) >> 8 & ( when MVDx = 0 ) \\ MVFx - MVx & ( when MVDx \neq 0 )\end{matrix} \qquad ( eq . 2 )$$

These equations (eq.2) substitute integer division with a series of multiplications, additions, subtractions, and comparison operations. For current microprocessors, these operations are easier to execute compared with integer division, and can be accomplished efficiently.

However, although such a calculation method can enhance the operational efficiency of the microprocessor, there is encountered the problem of inadequate accuracy. When such calculation method is actually applied to MPEG-4 decoding, the problem of truncation error will occur during the process of operation. FIG. 4 shows a table of the resultant values when used above method and correct values. Besides, the generated direct mode motion vectors MVF (MVFX and MVFy) and MVB (MVBX and MVBy) involving this truncation error will be at variance with the correct values, so that imprecise motion compensation may result during the picture decoding process, thereby degrading the picture quality.

### SUMMARY OF THE INVENTION

Therefore, one of the objects of this invention is to provide a direct mode motion vector calculation method for a bi-directionally predictive-coded picture, which can considerably decrease the calculation steps and reduce the operational difficulty without affecting the calculation accuracy.

Another object of this invention is to provide a bi-directionally predictive-coded picture decoding method for an MPEG-4 video object, which can considerably decrease the calculation steps and reduce the operational difficulty without affecting the calculation accuracy.

A method for calculating a direct mode motion vector for a bi-directionally predictive-picture includes: (A) calculating a first value S based on a value TRB representing a temporal distance between the bi-directionally predictive-picture and a first reference picture which is used for representing the bi-directionally predictive-picture, a value TRD representing a temporal distance between the first reference picture and a second reference picture which is also used for representing the bi-directionally predictive-picture, and a predetermined integer N; (B) calculating a second value Tx based on a first direction component MVx of a motion vector MV, the first value S, and the integer N; (C) calculating a third value Ty based on a second direction component MVy of the motion vector MV wherein the second direction is orthogonal to the first direction, the first value S, and the integer N; (D) obtaining a sum of the second value Tx, a first direction component MVDx of a differential motion vector MVD and a δ1x which is either 1 or 0, and using the obtained sum as a first direction component MVFx of a motion vector MVF corresponding to the first reference picture; (E) obtaining a sum of the third value Ty, a second component MVDy of the differential motion vector MVD and a δ1y which is either 1 or 0, and using the obtained sum as a second direction component MVFy of the motion vector MVF corresponding to the first reference picture; (F) obtaining a sum of the MVFx, a δ2x which is any one of −1, 0, and +1, and a minus value of the first direction component MVx, and using the obtained sum as a first direction component MVBx of a motion vector MVB corresponding to the second reference picture; and, (G) obtaining a sum of the MVFy, a δ2y which is any one of −1, 0, and +1, and a minus value of the second direction component MVy, and using the obtained sum as a second direction component MVBy of the motion vector MVB corresponding to the second reference picture.

Preferebly, the first reference picture is a list 0 reference picture and, the second reference picture is a list 1 reference picture.

Preferebly, the bi-directionally predictive-picture is included in a MPEG-4 video object.

Preferebly, in the (A) calculating a first value S, the first value S is calculated from a formula S=(TRB <<N)/TRD, where the operation TRB<<N denotes an N bit leftward bit-shift operation, whereby the TRB is shifted for N bits leftward in a binary manner; the operator “/” denotes an integer division; and the predetermined integer N is at least 12.

Preferebly, in the (B) calculating a second value Tx, the second value Tx is calculated from a formula Tx=(S*MVx)>>N, where the operation (S*MVx)>>N denotes an N bit rightward bit-shift operation in a binary manner, and in the (C) calculating a third value Ty, the third value Ty is calculated from a formula Ty=(S*MVy)>>N.

Preferebly, in the (D) obtaining a first direction component MVFX, the MVFx is calculated from a formula MVFx=Tx+δ1x+MVDx, and in the (E) obtaining a second direction component MVFy, the MVFx is calculated from a formula MVFy=Ty+δ1y+MVDy where the δ1x and the δ1y is determined as

$${δ}_{1 x} = \{ \begin{matrix}1 , & when ( MVx \geq 0 and Dx \geq TRD ) or ( MVx < 0 and Dx > 0 ) \\ 0 , & otherwise\end{matrix} \\ {δ}_{1 y} = \{ \begin{matrix}1 , & when ( MVy \geq 0 and Dy \geq TRD ) or ( MVy < 0 and Dy > 0 ) \\ 0 , & otherwise\end{matrix} \\ Dx = MVx ⨯ TRB - Tx ⨯ TRD \\ Dy = MVy ⨯ TRB - Ty ⨯ TRD .$$

Preferebly, in the (F) obtaining a first direction component MVBx, the MVBx is calculated from a formula below

$$MVBx = \{ \begin{matrix}Tx + {δ}_{1 X} + {δ}_{2 x} - MVx & ( when MVDx = 0 ) \\ MVFx - MVx & ( when MVDx \neq 0 )\end{matrix} ,$$

and in the (G) obtaining a second direction component MVBy, the MVBy is calculated from a formula below

$$MVBy = \{ \begin{matrix}Tx + {δ}_{1 y} + {δ}_{2 y} - MVy & ( when MVDy = 0 ) \\ MVFy - MVy & ( when MVDy \neq 0 )\end{matrix} ,$$

where the δ2x and the δ2y is determined as

$${δ}_{2 x} = \{ \begin{matrix}- 1 , & when Dx < {δ}_{1 x} ⨯ TRD \\ 0 , & when Dx = {δ}_{1 x} ⨯ TRD \\ 1 , & when Dx > {δ}_{1 x} ⨯ TRD\end{matrix} \\ {δ}_{2 y} = \{ \begin{matrix}- 1 , & when Dy < {δ}_{1 y} ⨯ TRD \\ 0 , & when Dy = {δ}_{1 y} ⨯ TRD \\ 1 , & when Dy > {δ}_{1 y} ⨯ TRD\end{matrix} .$$

in the (A) calculating a first value S, the first value S is obtained by executing a program Bin_Div(TRB<<N, TRD) which is executable by a processor, and the program Bin_Div(x,y) includes: setting a first Q value as 0, and setting a second Q value as a value obtained by performing a leftward N bits-shift operation of 1; setting a third Q value as a value obtained by performing a rightward 1 bit-shift operation of a sum of the first Q value and the second Q value; and, comparing between a value A, which is a product of the third Q value and the value y, and the value x; wherein the comparing includes: returning the third Q value in the case where the value x equals the value A; letting the first Q value be a value as the third Q value plus 1 in the case where the value x is greater that the value A; and, letting the second Q value be a value as the third Q value minus 1 in the case where the value x is smaller than the value A.

According to the present invention, a motion vector calculating method is provided. The method according to this invention is substantially identical to the equations for calculations of motion vectors according to the MPEG-4 specification and includes simpler and fewer operations than those of the MPEG-4 specification. Furthermore, the method according to this invention reduces the number of operations and operational difficulty without a loss of the calculation accuracy. The method according to this invention enhances the operational efficiency of a microprocessor drastically.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic diagram of picture encoding and an arrangement of pictures in an MPEG-4 video object;

FIG. 2A is a schematic diagram of a B-picture, a reference picture thereof and temporal distance therebetween, when a vector MVD is a zero vector;

FIG. 2B is a schematic diagram of a B-picture, a reference picture thereof and tempral distance therebetween, when a vector MVD is not a zero vector;

FIG. 3 is a diagram showing the operators in a direct mode block calculation equation provided in the MPEG-4 specification and data of the average number of operations therefor;

FIG. 4 is a comparison table showing the calculation results obtained with a direct mode block calculation equation disclosed in U.S. Patent Publication US2004/0066848, and the correct values;

FIG. 5 is a block diagram of an MPEG-4 decoder according to the preferred embodiment of this invention;

FIG. 6 is a flowchart of a part of a bi-directionally predictive-coded picture decoding method for an MPEG-4 video object according to the preferred embodiment of this invention, which illustrates a method for calculating motion vectors of direct mode blocks in a bi-directionally predictive-coded picture, and the decoding process; and

FIG. 7 is a table showing the operations included in the calculations according to the preferred embodiment and the number of operations.

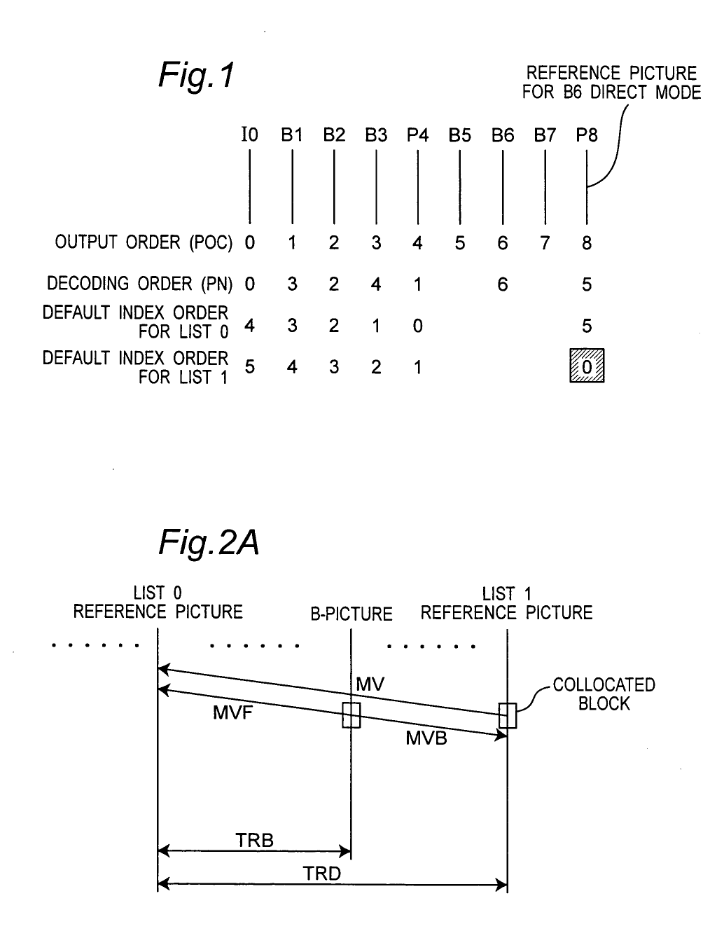

### DETAILED DESCRIPTION OF THE PREFERRED EMBODIMENTS

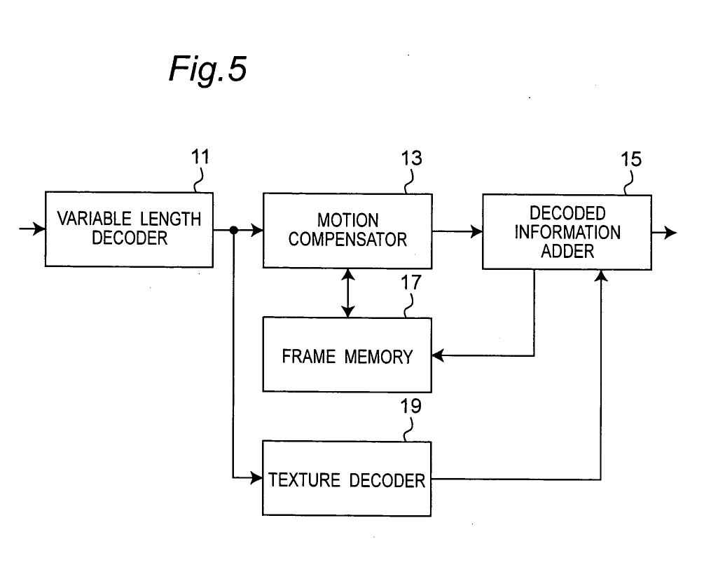

Referring to FIG. 5, a block diagram of a MPEG-4 decoder according to a preferred embodiment of this invention is shown. In processes for decoding pictures, a bit stream is input to a variable length decoder 11, and then the variable length decoder 11 decodes encoded data. The decoded data includes information on the encryption mode, i.e. Intra or Inter, for each macro block.

When the information on the encryption mode for a macro block indicates Intra, the encoded data may be decoded and output directly from a texture decoder 19. On the other hand, when the information on the encryption mode for the macro block indicates Inter, a motion compensator 13 generates a predictive frame based on motion compensation vectors, and then the generated predictive frame is added to an output from the texture decoder 19 in a decoded information adder 15 and output therefrom. The components of the MPEG-4 decoder according to the preferred embodiment of this invention may be embodied by one or more microprocessors.

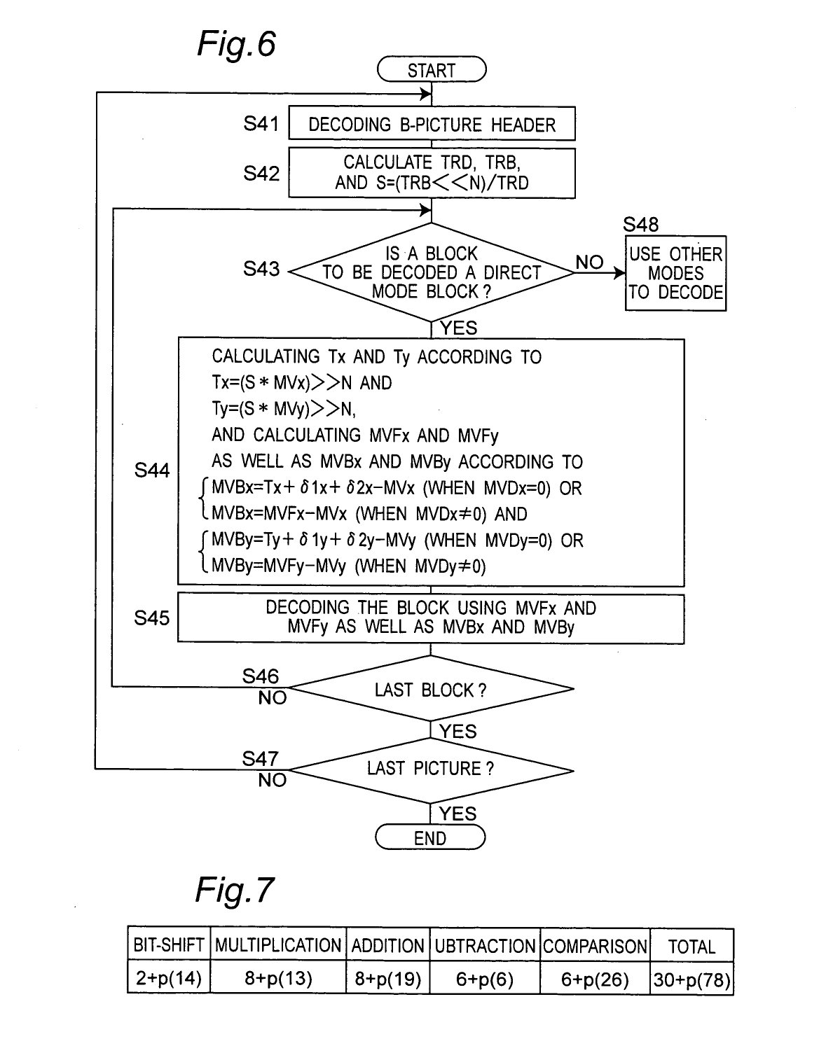

Referring to FIG. 6, this figure shows a flowchart of a bi-directionally predictive-coded picture decoding method for an MPEG-4 video object according to the preferred embodiment of this invention. The MPEG-4 video object includes a plurality of intra-coded pictures (I), bi-directionally predictive-coded pictures (hereinafter referred to as B-pictures), and predictive-coded pictures (hereinafter referred to as P-pictures).

Decoding processes for a B-picture according to the preferred embodiment of this invention will be described below. Initially, in step 41, a header of a B-picture is decoded by a microprocessor (not shown), for example. The decoded header includes information such as information on a list 1 reference picture (first reference picture) and a list 0 reference picture (second reference picture) of the B-picture, information on a motion vector MV between each block in the list 1 reference picture and a matching block in the list 0 reference picture, information on a differential motion vector MVD between each block in the list 1 reference picture and the block in the list 0 reference picture which is adjacent to the matching block and most similar to the block in the list 1 reference picture adjacent block, etc. The vectors MV and MVD may be expressed by two components corresponding to two axes, which are orthogonal to each other. The vector MV includes a horizontal component and a vertical component, i.e., MVD=(MVx, MVy), and the vector MVD includes a horizontal component and a vertical component, i.e., MVD=(MVDx, MVDy).

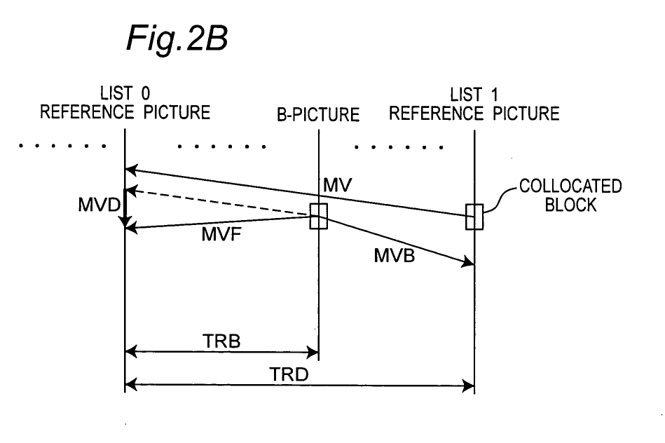

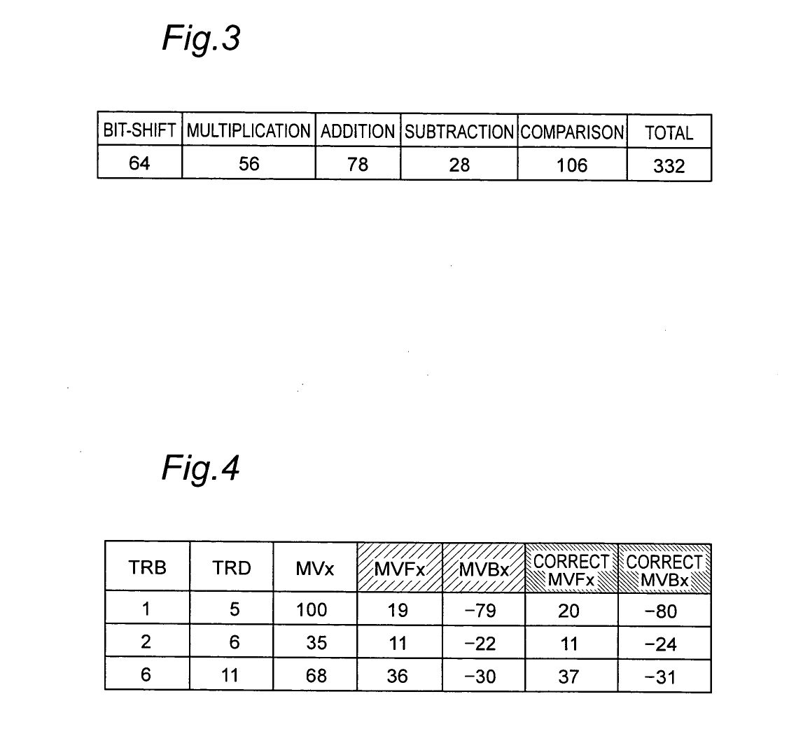

Then, step 42 is performed. Taking FIGS. 2A and 2B as an example, based on the arrangement of positions of the list 0 reference picture and the list 1 reference picture relative to the B-picture, the temporal distance TRB between the list 0 reference picture and the B-picture, i.e. a first time, and the temporal distance TRD between the list 0 reference picture and the list 1 reference picture, i.e. a second time, are obtained. A Value S, i.e. a first value, is obtained from a following equation:
S=(TRB<<N)/TRD=Bin_Div(TRB<<N, TRD) (eq. 3)
where the operator “<<” means a bit-shift operation to left, for example, the operation “TRB<<N” means that TRB is shifted to the left by N (=12) bits in a binary manner; the N is set to 12 according to the specification of MPEG-4; the operator “/” means the integer division, that is, the division operation with rounding toward zero; and the rightmost term Bin_Div(x,y) is described later.

Then step S43 is performed for each block, prior to decoding of the each block. At step S43, the each block is checked whether the block is a direct mode block or not. If the block is a direct mode block, then step S44 is carried out. Otherwise, step S48 is carried out to decode the block using other method adequate for the mode of the block. Descriptions for processes for the block which is not a direct mode-block is omitted since they are not concerned directly to this invention.

One of the features of this preferred embodiment resides in the carrying out a process which is included in step S44 in large part to obtain the direct mode list 0 motion vector MVF=(MVFx, MVFy), i.e. a first motion vector, and the list 1 motion vector MVB=(MVBX, MVBy), i.e. a second motion vector, of each block. The method of the process (calculation) is as follows:

$$Tx = ( S ⨯ MVx ) >> N \\ Ty = ( S ⨯ MVy ) >> N \\ MVFx = Tx + {δ}_{1 x} + MVDx \\ MVFy = Ty + {δ}_{1 y} + MVDy \\ MVBx = \{ \begin{matrix}Tx + {δ}_{1 x} + {δ}_{2 x} - MVx & ( when MVDx = 0 ) \\ MVFx - MVx & ( when MVDx \neq 0 )\end{matrix} \\ MVBy = \{ \begin{matrix}Tx + {δ}_{1 y} + {δ}_{2 y} - MVy & ( when MVDy = 0 ) \\ MVFy - MVy & ( when MVDy \neq 0 )\end{matrix} \qquad ( eq . 4 )$$

where 2^{N}<|MVx|, and N is selected as 12 according to the MPEG-4 specification. The value Tx, i.e. a second value, is obtained from a N bit-shift operation to right on (S*MVx) in a binary manner. The value Ty, i.e. a third value, may be obtained similarly. Calculations for obtaining the MVBx, which is the x component of the list 1 motion vector, is alternately used according to the value of x component of the differential motion vector MVD, i.e. MVDx.
If MVDx=0,
then MVBx=Tx+δ₁ₓ+δ₂ₓ−MVx,
otherwise, MVBx=MVFx−MVx.
Similarly, the calculations for obtaining the MVBy, which is the y component of the list 1 motion vector, is alternately used according to the value of y component of the differential motion vector MVD, i.e. MVDy.
If MVDy=0,
then MVBy=Ty+δ_{1y}+δ_{2y}−MVy,
otherwise, MVBy=MVFy−MVy.
It is to be noted that, the formula for the case that the MVDX is not zero can be included to the formula for the case that the MVDx is zero, by letting δ₂ₓ be zero instead of the use of the formula for δ₂ₓ defined below. Similarly, the formula for the case that the MVDy is not zero can be included to the formula for the case that the MVDy is zero, by letting δ_{2y} be zero instead of the use of the formula for δ_{2y}, defined below.

The variables, δ₁ₓ, δ_{1y}, δ₂ₓ, δ_{2y}, in the above equation are defined as follows:

$${δ}_{1 x} = \{ \begin{matrix}1 , & when ( MVx \geq 0 and Dx \geq TRD ) or ( MVx < 0 and Dx > 0 ) \\ 0 , & otherwise\end{matrix} \\ {δ}_{1 y} = \{ \begin{matrix}1 , & when ( MVy \geq 0 and Dy \geq TRD ) or ( MVy < 0 and Dy > 0 ) \\ 0 , & otherwise\end{matrix} \\ {δ}_{2 x} = \{ \begin{matrix}- 1 , & when Dx < {δ}_{1 x} ⨯ TRD \\ 0 , & when Dx = {δ}_{1 x} ⨯ TRD \\ 1 , & when Dx > {δ}_{1 x} ⨯ TRD\end{matrix} \\ {δ}_{2 y} = \{ \begin{matrix}- 1 , & when Dy < {δ}_{1 y} ⨯ TRD \\ 0 , & when Dy = {δ}_{1 y} ⨯ TRD \\ 1 , & when Dy > {δ}_{1 y} ⨯ TRD\end{matrix} \\ Dx = MVx ⨯ TRB - Tx ⨯ TRD \\ Dy = MVy ⨯ TRB - Ty ⨯ TRD \qquad ( eq . 5 )$$

The δ₁ₓ is a value alternately determined as 1 or 0 depending on the sign of the MVx (the case MVx is zero may be included in the case of the positive sign) and the values Dx and TRD. Similarly, the δ_{1y} is a value alternately determined as 1 or 0 depending on the sign of the MVy (the case MVy is zero may be included in the case of the positive sign) and the values Dy and TRD. The δ₂ₓ is a value determined as −1, 0, or, +1, depending on the magnitude relation between a product of the value δ₁ₓ and the value TRD and the value Dx. The δ_{2y} is a value determined as −1, 0, or, +1, depending on the magnitude relation between a product of the value δ_{1y}, and the value TRD and the value Dy. The value Dx is a value obtained from the values MVx, TRB, Tx, and, TRD and the value Dy is a value obtained from the values MVy, TRB, Ty, and, TRD.

At step S44 the direct mode motion vectors MVFx, MVFy, MVBx, and, MVBy, and then, the block is decoded based on the motion vectors MVF=(MVFx, MVFy) and MVB=(MVBx, MVBy) at step S45.

Next, step S46 is performed to check whether another block to be decoded does exist or not. When the block to be decoded exists (YES at step S46), steps S43, S44, S45, S46, and, S48 are performed repeatedly until no other blocks to be decoded exists. Step S47 is performed thereafter to check whether another B-picture to be decoded does exist or not. When the B-picture to be decoded exists (YES at step S47), steps S41, S42, S43, S44, S45, S46, and, S48 are repeated until no other B-pictures to be decoded exists.

[Search Algorithm Bin_Div(x,y)]

As mentioned previously, this embodiment may use the search algorithm Bin_Div(x,y) to obtain the value S. This algorithm is can be written in pseudo-codes as follows:

```
Bin_Div(x,y)
{
    Qmin = 0
    Qmax = 1<<N
    do
        Q = (Qmin + Qmax) >> 1
        A = Q * y
        if (x = A) return Q
        if (x > A) Qmin = Q + 1
        if (x < A) Qmax = Q − 1
    while (Qmin <= Qmax)
    return Q
}
```

The algorithm Bin_Div(x,y) is a conventional one. In this conventional algorithm, a value Q, i.e. a third Q value, is determined as the mid-value of the range defined between a value Qmin, i.e. a first Q value, and a value Qmax, i.e. a second Q value (Q=(Qmin+Qmax)>>1), and a magnitude relation between a product A, which is a product of the value Q and a value y (A=Q*y), and a value x is determined. If x is greater than the A, then a new Qmax is set to Q+1 and the above mentioned determination of the magnitude relation is performed. If x is smaller than the A, then the new Qmax is set to Q−1 and the above mentioned determination of the magnitude relation is performed. These operations are performed again until x becomes identical to the product A or a particular condition breaks (while (Qmin<=Qmax)).

Proof of an equivalence (interchangeability) between the motion vector calculation method of the MPEG-4 specification and the motion vector calculation method according to the preferred embodiment of this invention is described next.
Hereinbelow, it is demonstrated that the formulae for obtaining MVFx (, MVFy, MVBX, and, MVBy) according to the preferred embodiment are equivalent to (interchangeable with) the formulae according to the MPEG-4 specification and that the formulae according to the preferred embodiment generates no truncation error. First, two theorems and their proofs are demonstrated.

Theorem 1:
Assuming that 0<b<c, 0<=|a|<K, ab/c=((Kb/c)·a)////K+δ for integers a, b, c and K: if (a>=0and D>=c) or (a<0 and D>0), then δ=1; otherwise δ=0.
Where D=ab−c(((Kb/c)·a)////K), the operator “////” denotes a division that the result is the largest integer not greater than the quotient.

Proof 1:
First, we prove that δmust be 1 or 0. It is to be noted that operations represented as

$$\frac{x}{y}$$

and x/y are different each other. The former is a division operation without rounding, whereas the latter is an integer division operation of which result is an integer being the same sign as the quotient

$$( \frac{x}{y} )$$

and the absolute value of the result is a largest integer that does not exceed the absolute value of the quotient.

Therefore,

$$\frac{x}{y} = x / y + r ,$$

where x/y is an integer and 0<=|r|<|y|. Let

$$\frac{ab}{c} = u + \frac{r}{c} ,$$

where u and r are integers, and 0<=|r|<c, then ab/c=u. Let

$$\frac{Kb}{c} = m + \frac{q}{c} ,$$

where m and q are integers, and 0<=q<c, then Kb/c=m.

Assuming that

$$\begin{matrix}\frac{( Kb / c ) \cdot a}{K} = \frac{ma}{K} \\ = \frac{( \frac{Kb}{c} - \frac{q}{c} ) \cdot a}{K} \\ = u + \frac{r}{c} - \frac{pq}{cK} \text{:} - 1 < \frac{r}{c} - \frac{aq}{cK}\end{matrix}$$

<1 Since 0 <=|r|<c, 0<=q<c, and 0 <=|a|<K.

Hence, u−1<

$$\frac{( Kb / c ) \cdot a}{K}$$

<u+1<->(Kb/c)·a////K=u or u−1.
It can thus be proved that δis 0 or 1.

Then, we prove the theorem 1:
Assuming that y=((Kb/c)·a)////K:
   when a>=0;
and if δ=1;
ab/c=y+1
<->ab=c(y+1)+s (0<=s<c),
<->ab−cy=D=c+s>=c;
or, alternately, if δ=0;
ab/c=y
<->ab=cy+t(0 <=t<c),
<->ab−cy=D=t<c;
   or, when a<0;
and if δ=1;
ab/c=y+1
<->ab=c(y+1)+w(−c<w<=0),
<->ab−cy=D=c+w>0;
or, alternately, if δ=0;
ab/c=y,
<->ab=cy+v(−c<v<=0),
<->ab−cy=D=v<=0.
   It can thus be proved that the theorem 1 is valid.

Moreover, in order to apply the theorem 1 to this embodiment, letting K=2^{N}, for an integer M, MK is expressed as M<<N(MK=M<<N) and the operation M////K is expressed as M>>N(M////K =M>>N). Therefore, the formulae for obtaining MVFx and MVFy according to this preferred embodiment of this invention is equivalent to the formulae according to the MPEG-4 specification (ISO/IEC14496-2).

Theorem 2:
Assuming that 0 <b<c, a(b−c)/c=ab/c−a+ε for integers a, b,and c:
if E>0, ε=1;
if E=0, ε=0;
if E<0, ε=−1;
   where E=ab−c(ab/c).

Proof 2:
When a >=0, for integers u and r (0 <=r<c),

$$\frac{ab}{c} = u + \frac{r}{c} ,$$

and therefore ab/c=u.
Hence,

$$\begin{matrix}\frac{a ( b - c )}{c} = \frac{ab - a c}{c} \\ = \frac{cu + r - a c}{c} \\ = \frac{c ( u - a ) + r}{c} \\ = u - a + \frac{r}{c} .\end{matrix}$$
if r=0, then a(b−c)/c=u−a,
   or if r>0, then a(b−c)/c=u−a+1.
   Otherwise, when a<0, since u−a<=0 (u=ab/c, and 0 <b<c) and r=ab−cu=ab−c(ab/c),
when a<0, for integers v and q(−c<q<=0),

$$\frac{ab}{c} = v + \frac{q}{c} ,$$

and therefore ab/c=v.
Hence,

$$\begin{matrix}\frac{a ( b - c )}{c} = \frac{ab - a c}{c} \\ = \frac{cv + q - a c}{c} \\ = \frac{( v - a ) + q}{c} \\ = v - a + \frac{q}{c} .\end{matrix}$$
If q=0, then a(b−c)/c=v−a,
   or if q<0, then a(b−c)/c =v−a−1,
   where v−a>=0(v=ab/c, and 0<b<c) and q=ab−cv=ab−c(ab/c).
   It can thus be proved that the theorem 2 is valid. Therefore, the formulae for obtaining MVBx and MVBy according to this preferred embodiment of this invention is equivalent to the formulae according to the MPEG-4 specification (ISO/IEC14496-2).

Therefore, the operational equations of this embodiment not only can be an equivalent transformation and replacement of the equations in the MPEG-4 specification, they can also simplify the computational complexity of the conventional equations. FIG. 7 shows the computational operations used in this embodiment to calculate the direct mode motion vectors of a block, and the average number of operations, where p(x)=x/(the total number of blocks in a B-picture). For instance, for a 320×240 picture, there are 20×15 16×16 blocks. Hence, p(x)=(x/(20×15)) is about 0.003×. Therefore, compared with the conventional equations, this embodiment can reduce the number of operations from 332 to 30+p(78)=30.26, and achieves a reduction of about 90%.

Certainly, although the description in this embodiment is directed to the calculations of the motion vectors of a B-picture direct mode block for the list 0 reference picture and list 1 reference picture of a specific type as shown in FIGS. 2A and 2B, this embodiment can also be used to calculate the direct mode motion vectors of a B-picture of the list 0 reference picture and list 1 reference picture of a different type as shown in FIGS. 6(B) and 6(C) of US2004/0066848. The difference merely resides in the point that the TRD, TRB, MV, and MVD values are different. In addition, although this embodiment is directed to the decoding of pictures in the frame mode (i.e., list 0 reference picture, list 1 reference picture and B-picture are all in the frame mode), for pictures in another field mode (i.e., list 0 reference picture, list 1 reference picture and B-picture are all in the field mode) or in different modes (i.e., list 0 reference picture, list 1 reference picture and B-picture may be in the frame mode or the field mode) as shown in Fig. 7 to FIG. 13 of US2004/0066848, the calculation method of this embodiment can still be used to calculate the direct mode motion vectors of a B-picture without any problem.

Therefore, after obtaining the direct mode motion vectors MVFX, MVFy, MVBx and MVBy of the block in step S44, step S45 is carried out to decode the block based on the motion vectors MVFx, MVFy, MVBx and MVBy. Then, step S46 is performed to determine whether there is any block that has yet to be decoded. In the affirmative (YES in step S46), steps S43 to S45 are repeated until all the blocks in the same B-picture have been decoded. Thereafter, step S47 is carried out to determine whether there is any B-picture that has yet to be decoded. In the affirmative (YES in S47), steps S41 to S46 are repeated until all the B-pictures have been decoded. In summary, in step 44 of this embodiment, by providing calculation equations that have simple calculation steps and that are capable of equivalent substitution or transformation of the equations in the MPEG-4 specification for calculating direct mode block motion vectors, the operational steps and computational complexity can be considerably simplified, and the working efficiency of the microprocessor can be enhanced without affecting the accuracy of picture calculation results.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

The method for calculating a direct mode motion vector of a bi-directionally predictive picture according to this invention is useful in calculating a direct mode motion vector etc. used in MPEG and the like. The method according to this invention is equivalent to the method according to the MPEG-4 specification and includes only simpler operation and less computational steps than those included in the method of MPEG-4 specification.

What is claimed is:

1. A method for calculating a direct mode motion vector for a bi-directionally predictive-picture comprising:
(A) calculating a first value S based on a value TRB representing a temporal distance between the bi-directionally predictive-picture and a first reference picture which is used for representing the bi-directionally predictive-picture, a value TRD representing a temporal distance between the first reference picture and a second reference picture which is also used for representing the bi-directionally predictive-picture, and a predetermined integer N;
(B) calculating a second value Tx based on a first direction component MVx of a motion vector MV, the first value S, and the integer N;
(C) calculating a third value Ty based on a second direction component MVy of the motion vector MV wherein the second direction is orthogonal to the first direction, the first value S, and the integer N;
(D) obtaining a sum of the second value Tx, a first direction component MVDx of a differential motion vector MVD and a δ1x which is either 1 or 0, and using the obtained sum as a first direction component MVFx of a motion vector MVF corresponding to the first reference picture;
(E) obtaining a sum of the third value Ty, a second component MVDy of the differential motion vector MVD and a δ1y which is either 1 or 0, and using the obtained sum as a second direction component MVFy of the motion vector MVF corresponding to the first reference picture;
(F) obtaining a sum of the MVFx, a δ2x which is any one of −1, 0, and +1, and a minus value of the first direction component MVx, and using the obtained sum as a first direction component MVBx of a motion vector MVB corresponding to the second reference picture; and,
(G) obtaining a sum of the MVFy, a δ2y which is any one of −1, 0, and +1, and a minus value of the second direction component MVy, and using the obtained sum as a second direction component MVBy of the motion vector MVB corresponding to the second reference picture.

2. The method according to claim 1,
wherein the first reference picture is a list 0 reference picture and,
the second reference picture is a list 1 reference picture.

3. The method according to claim 1,
wherein the bi-directionally predictive-picture is included in a MPEG-4 video object.

4. The method according to claim 1, wherein,
in the (A) calculating a first value S, the first value S is calculated from a formula S=(TRB<<N)/TRD, where the operation TRB<<N denotes an N bit leftward bit-shift operation, whereby the TRB is shifted for N bits leftward in a binary manner; the operator “/” denotes an integer division; and the predetermined integer N is at least 12.

5. The method according to claim 4, wherein,
in the (B) calculating a second value Tx, the second value Tx is calculated from a formula Tx=(S*MVx)>>N, where the operation (S*MVx)>>N denotes an N bit rightward bit-shift operation in a binary manner,
and in the (C) calculating a third value Ty, the third value Ty is calculated from a formula Ty=(S*MVy)>>N.

6. The method according to claim 5, wherein,
in the (D) obtaining a first direction component MVFx, the MVFx is calculated from a formula MVFx=Tx+δ1x+MVDX, and in the (E) obtaining a second direction component MVFy, the MVFx is calculated from a formula MVFy=Ty+δ1y +MVDy where the δ1x and the δ1y is determined as
$${δ}_{1 , x} = \{ \begin{matrix}1 , & \begin{matrix}when ( MVx \geq 0 and Dx \geq TRD ) \\ or ( MVx < 0 and Dx > 0 )\end{matrix} \\ 0 , & otherwise\end{matrix} \\ {δ}_{1 y} = \{ \begin{matrix}1 , & \begin{matrix}when ( MVy \geq 0 and Dy \geq TRD ) \\ or ( MVy < 0 and Dy > 0 )\end{matrix} \\ 0 , & otherwise\end{matrix} \\ Dx = MVx ⨯ TRB - Tx ⨯ TRD \\ Dy = MVy ⨯ TRB - Ty ⨯ TRD .$$

7. The method according to claim 6, wherein,
in the (F) obtaining a first direction component MVBX, the MVBx is calculated from a formula below
$$MVBx = \{ \begin{matrix}Tx + {δ}_{1 x} + {δ}_{2 x} - MVx & ( when MVDx = 0 ) \\ MVFx - MVx & ( when MVDx \neq 0 )\end{matrix} ,$$
and in the (G) obtaining a second direction component MVBy, the MVBy is calculated from a formula below
$$MVBy = \{ \begin{matrix}Tx + {δ}_{1 y} + {δ}_{2 y} - MVy & ( when MVDy = 0 ) \\ MVFy - MVy & ( when MVDy \neq 0 )\end{matrix} ,$$
where the δ2x and the δ2y is determined as
$${δ}_{2 x} = \{ \begin{matrix}- 1 , & when Dx < {δ}_{1 x} \times TRD \\ 0 , & when Dx = {δ}_{1 x} \times TRD \\ 1 , & when Dx > {δ}_{1 x} \times TRD\end{matrix} \\ {δ}_{2 y} = \{ \begin{matrix}- 1 , & when Dy < {δ}_{1 y} \times TRD \\ 0 , & when Dy = {δ}_{1 y} \times TRD \\ 1 , & when Dy > {δ}_{1 y} \times TRD\end{matrix}$$

8. The method according to claim 1,
wherein, in the (A) calculating a first value S, the first value S is obtained by executing a program Bin_Div(TRB<<N, TRD) which is executable by a processor,
and the program Bin_Div(x,y) comprises:
setting a first Q value as 0, and setting a second Q value as a value obtained by performing a leftward N bits-shift operation of 1;
setting a third Q value as a value obtained by performing a rightward 1 bit-shift operation of a sum of the first Q value and the second Q value; and,
comparing between a value A, which is a product of the third Q value and the value y, and the value x;
wherein the comparing comprises:
returning the third Q value in the case where the value x equals the value A;
letting the first Q value be a value as the third Q value plus 1 in the case where the value x is greater that the value A; and,
letting the second Q value be a value as the third Q value minus 1 in the case where the value x is smaller than the value A.
